(19) United States
(12) Patent Application Publication
(10) Pub. No.: US 2022/0081280 A1
(43) Pub. Date: Mar. 17, 2022

(54) EQUESTRIAN SADDLE TREE MADE OF COMPOSITE MATERIAL

(71) Applicant: GROUPE VOLTAIRE SAS, Bidart (FR)

(72) Inventors: Brice Goguet, Bidart (FR); Simon Falgaronne, Urt (FR); Mathilde Prevost, Bidart (FR)

(21) Appl. No.: 17/420,642

(22) PCT Filed: Jan. 10, 2020
(86) PCT No.: PCT/EP2020/050520

§ 371 Date: Jul. 2, 2021

(30) Foreign Application Priority Data
Jan. 11, 2019 (FR) 1900282

(51) Int. Cl. B68C 1/02

(52) U.S. Cl. CPC B68C 1/025

(57) ABSTRACT

Equestrian saddle tree comprising a frame forming a pommel and a cantle that are connected by lateral strips. This saddle tree consists of a single piece of composite material, the reinforcement of which has a plurality of superposed layers of sheet material and the matrix of which consists of at least one resin. The frame has: —a first ply having at least one layer of sheet material, this first ply constituting a framework that has an internal contour delimiting a central opening; —a second ply that is superposed on the first ply and has at least one layer of sheet material, the second ply furthermore extending over the central opening and forming a rider's seat.

### TECHNICAL FIELD

The invention relates to the field of horse-riding equipment and concerns an equestrian saddle tree.

Equestrian saddles are used to seat and support a rider on a mount such as a horse. Among the different types of equestrian saddles known, the saddles allowing so-called “English” riding are generally made up of a saddle tree which is a frame forming the pommel and the cantle of the saddle. A complete equestrian saddle comprises such a saddle tree and generally receives equipment such as stirrup bars, girths, fenders, etc. A seat for the rider is moreover mounted to the saddle tree.

### BACKGROUND

Patent application FR2931140 describes such an equestrian saddle tree. This saddle tree is associated with a generally bed-shaped part which is limited by an outer free edge comprising a pommel part, a cantle part and two longitudinal parts. This external free edge is able to cooperate with an internal free edge complementary to the saddle tree. The bed comprises elementary strip-shaped parts, two adjacent strips being separated from each other by a slit. When combined with a saddle tree adapted to receive it, this generally bed-shaped part makes it possible to reconcile some rigidity offering good protection of the mount and some flexibility adapted to the rider's comfort.

Although equestrian saddles of prior art represent an improvement in ergonomics for the rider and the mount, this ergonomics can still be improved as well as the consistency in the dynamic behavior of the whole.

### SUMMARY

The purpose of the invention is to improve equestrian saddle trees of prior art.

To this end, the invention is directed to an equestrian saddle tree comprising a frame forming a pommel and a cantle which are connected by lateral strips, this saddle tree consisting of a single piece of composite material, the reinforcement of which comprises a plurality of superimposed layers of sheet material and the matrix of which consists of at least one resin. The frame comprises:
a first ply comprising at least one layer of sheet material, this first ply making up a framework which has an inner contour defining a central opening;
a second ply superimposed on the first ply and comprising at least one layer of sheet material, the second ply additionally extending over the central opening and making up a rider's seat.

Such a saddle tree is made of composite material for lightness, rigidity, and flexibility properties provided by these materials. Making it of composite material further allows the saddle tree to be made of two plies of sheet material. The first ply is formed by at least one layer of sheet material, and preferably several such layers. This first ply only participates in the main function of the saddle tree (making a frame) by providing a framework participating in making the frame. The second ply is also formed by at least one layer of sheet material, and preferably several such layers. This second ply also participates in the main function of the saddle tree, completing the framework of the first ply to form the frame, and further integrates a rider's seat into the saddle tree structure itself, so that this seat is connected to the entire surface of the frame.

Such a saddle tree can be directly equipped with a saddle seat (usually upholstered leather) resting on the second ply and does not require any canvas or stretched structure (such as “false seats”) underneath this seat or any attachments to the saddle tree. The saddle tree according to the invention is as a single piece which performs, on the one hand, an interface function with the mount with the consequent constraints of rigidity and ergonomics for the mount, and performs on the other hand an interface function with the rider by mechanically ensuring the maintenance of his/her seat, with the consequent constraints of flexibility and ergonomics for the rider. Moreover, these two functions are linked to each other by the general structure made of layers of sheet material. Indeed, the saddle tree links these two functions in such a way that, during dynamic phases of riding, movements of the mount and the rider are intimately linked by the presence, within the stack of layers of sheet material, of some layers providing the frame function and other layers providing a seating function.

Moreover, the saddle tree according to the invention allows the implementation of manufacturing methods with a high repeatability, especially compatible with quality certification requirements, because it is produced in a single piece and does not require the manual installation of canvas or stretched structure on a frame, nor the attachment of an independent flexible part. Production means in accordance with the rules of the art of composite materials thus allow mass production of the saddle tree. The invention allows the implementation of manufacturing methods that ensure uniformity of the saddle trees produced and mechanical stability of each saddle tree over time.

The saddle tree according to the invention thus has advantages in its static behavior (comfort of the rider and comfort of the mount) and advantages in its dynamic behavior (link between the functions of interface with the rider and interface with the mount) which limit resonance phenomena between the movement of the rider's seat and the movement of the mount's back.

The saddle tree according to the invention may comprise the following additional characteristics, alone or in combination:
the first ply consists of a plurality of layers of sheet material;
the layers of sheet material of the first ply are layers of wood sheets;
the second ply consists of a plurality of layers of sheet material;
the layers of sheet material of the second ply are sheet layers of woven fibers;
the woven fibers are carbon fibers;
the saddle tree comprises a reinforcing panel disposed against the first ply, at the pommel, on the side of the first ply opposite to the second ply;
the saddle tree comprises a window provided in the first ply, the second ply and the reinforcing panel being attached to each other through the window, in a junction zone;
the reinforcing panel is made by a stack of layers of a same sheet material as the sheet material of the second ply;
the reinforcing panel comprises a matrix made of the same resin forming the matrix of the second ply, this resin also being present in the junction zone between the second ply and the reinforcing panel;
the second ply comprises through grooves facing the central opening;
the grooves are arranged in a staggered pattern;
the grooves are arranged along lines that substantially follow the shape of the inner contour of the framework;
at least one of the grooves is V-shaped, the tip of this V-shape being disposed in a vertical plane intersecting longitudinally the saddle tree.

With respect to the latter characteristic, the vertical direction, in which the vertical plane longitudinally intersecting the saddle tree extends, is defined with respect to the saddle tree as the orientation it adopts in the position for mounting the mount, that is, when the rider's seat is facing upwards and the central opening is facing downwards.

The invention also relates to an equestrian saddle tree comprising a frame, this saddle tree being characterized in that it is made of a single piece, the frame comprising:
a first ply forming a framework which has an inner contour delimiting a central opening;
a second ply superimposed on the first ply, the second ply extending over the central opening so as to form a rider's seat integrated with the frame.

### BRIEF DESCRIPTION OF THE DRAWINGS

Further characteristics and advantages of the invention will become apparent from the description thereof made hereinafter, by way of indicating and not in any way limiting purposes, with reference to the appended drawings, in which:

FIG. 1 is a perspective view of an equestrian saddle tree according to the invention, seen from the rear;

FIG. 2 is a perspective view from the front of the saddle tree of FIG. 1;

FIG. 3 is a front view of the saddle tree of FIG. 1;

FIG. 4 is a side view of the saddle tree of FIG. 1;

FIG. 5 is a detail view of the V insert of FIG. 3;

FIG. 6 is a schematic exploded view of a detail of FIG. 3;

FIG. 7 is a cross-section view, along the cross-section AA of FIG. 4;

FIG. 8 is a top view of the saddle tree of FIG. 1;

FIG. 9 is a schematic view similar to FIG. 8.

### DETAILED DESCRIPTION

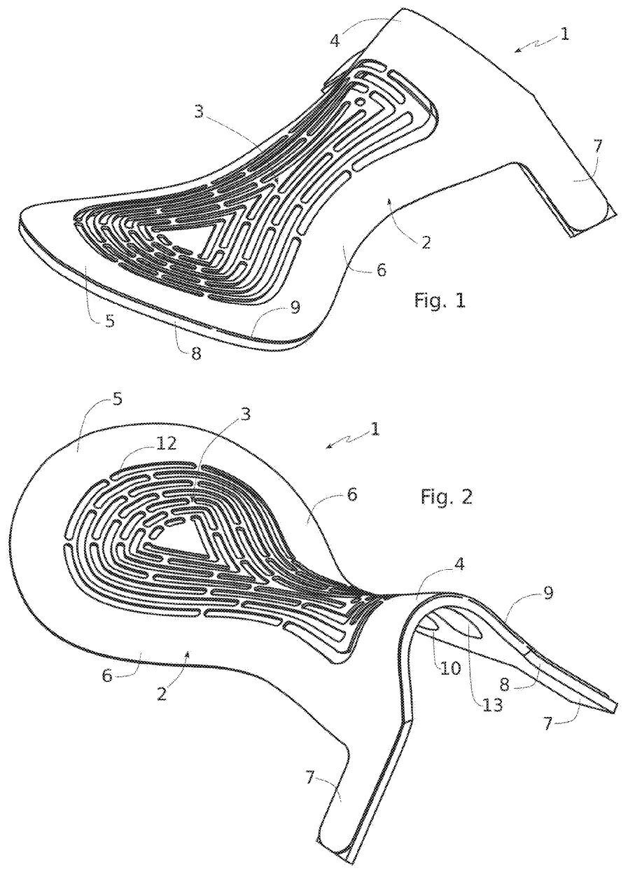

FIGS. 1 and 2 represent in a perspective view an example of a horse saddle tree according to the invention. Such a saddle tree is the central component of an equestrian saddle. The other components of the equestrian saddle are otherwise known and will not be described in more detail here.

The saddle tree 1 is in the form of a single piece of composite material and comprises no mechanical assemblies. The saddle tree 1 integrates a frame 2 as well as a rider's seat 3. The saddle tree 1 has a front part and a rear part corresponding respectively to the front and the rear of the frame. On its front part, the frame 2 comprises an arch forming the pommel 4 of the saddle tree 1. The shape of the frame 2 on its rear part in turn makes up the cantle 5 of the saddle tree 1. The frame 2 further comprises two lateral strips 6 connecting the pommel 4 and the cantle 5. The saddle tree 1 also has two spikes 7 especially for receiving the stirrup bars (not represented). Optionally, the cantle 5 can receive an attachment (not shown) for obtaining a particular shape for this portion of the rear of the saddle.

The saddle tree 1 is made of a composite material, the reinforcement of which consists of a plurality of superimposed layers of sheet material, and the matrix of which consists of a resin. The layers of sheet material are superimposed in a first ply 8 and in a second ply 9. Each of the plies 8, 9 comprises at least one layer of sheet material. Preferably, each of the plies 8, 9 comprises several layers of sheet material.

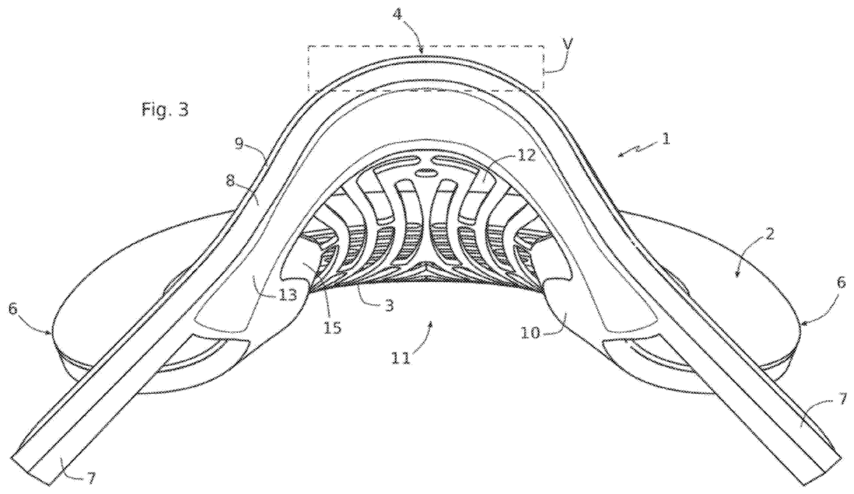

FIG. 3 is a front view of the front part of the saddle tree 1. The slice of the saddle tree 1 that is visible in this view shows the superimposition of the first ply 8 and the second ply 9. In the present example, each of the plies 8, 9 consists of several layers of sheet material. However, for the sake of simplicity, the individual layers making up each of the plies 8, 9 have not been represented in the figures, except in FIG. 5, and will be described in more detail with reference to FIG. 5.

FIG. 3 shows that the first ply 8 makes up a framework 10 extending around the perimeter of the saddle tree 1. This framework 10 comprises a central opening 11.

In the present example, the first ply 8 consists of superimposed wood sheets secured by a matrix made of a resin adapted to wood, for example a polyurethane resin. For making the first ply 8, the wood sheets are shaped according to the curves required for the framework 10 and are then bonded or embedded in the resin.

The second ply 9 is placed on the first ply 8. At the interface between the first ply 8 and the second ply 9, the lower layer of sheet material of the second ply 9 is secured by resin to the upper layer of sheet material of the first ply 8 (the terms lower layer and upper layer refer to the orientation of the saddle tree as shown in FIG. 3).

The second ply 9 consists, in the present example, of a superimposition of woven carbon fiber sheets embedded in an adapted resin.

The second ply 9 extends over the framework 10 and also extends over the central opening 11. The frame 2 of the saddle tree 1 consists of the framework 10 and by the portion of the second ply 9 that is superimposed on this framework 10.

The saddle tree 1 thus consists of a multicomposite material whose reinforcement consists of a plurality of superimposed layers of sheet material and whose matrix consists of a resin. The extent of the second ply 9 of sheet material differs from the first ply 8 in that it also extends over the central opening 11 left by the framework 10. The second ply thus fulfills a second function (in addition to its first function of participating in constituting the frame 2 together with the first ply 8) which is to make a rider's seat.

In the present example, the first ply 8 and the second ply 9 consist of layers of different materials having as a matrix the same resin or, on the contrary, two different resins each adapted to the respective material of the plies 8, 9 (the resin present at the interface of the plies 8, 9 having to be compatible with both types of sheet materials).

Alternatively, the first ply 8 and the second ply 9 can consist of layers of the same sheet material, all with a same resin as a matrix.

The second ply 9 thus forms a membrane, the portion of which extending opposite to the central opening 11 comprises grooves 12.

With reference to FIG. 3, the saddle tree 1 further comprises a reinforcing panel 13 disposed under the first ply 8, at the pommel 4. The reinforcing panel 13 is here made of a plurality of layers of sheet material in a resin matrix, which sheet material and resin are identical to those of the second ply 9.

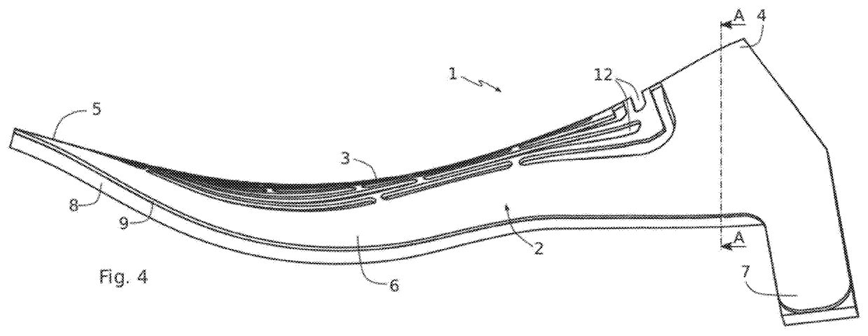

FIG. 4 is a side view of the saddle tree 1 showing the superimposition of the layers of sheet material of plies 8, 9 throughout the perimeter of the saddle tree 1. The grooves 12 of the second ply 9 are also visible in this side view of FIG. 4.

FIG. 5 is an enlarged view the V insert in FIG. 3. This FIG. 5 shows the detail of the stack of layers of sheet material according to the present example. The first ply 8 is made by superimposing a dozen wood sheets of 1 millimeter thickness.

The second ply 9 in turn comprises, according to this example, six layers of braided carbon fiber sheets with a basis weight of 400 g/m².

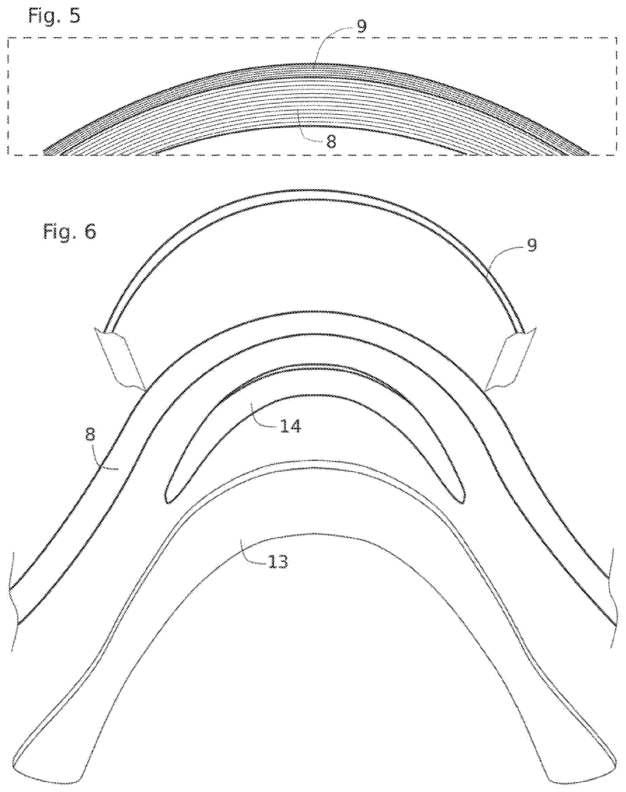

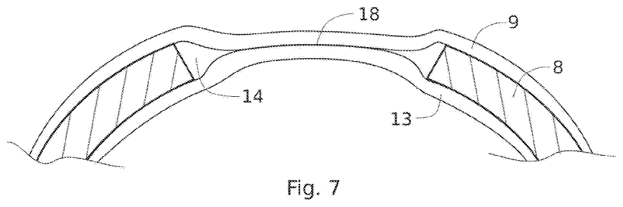

The cooperation of the reinforcing panel 13 and the second ply 9 is described with reference to FIGS. 6 and 7.

FIG. 6 is a partial exploded view of the pommel 4 of the saddle tree 1 showing the reinforcing panel 13 separated from the rest of the saddle tree 1. The reinforcing panel 13 and the second ply 9 are connected at a window 14 provided in the first ply 8.

FIG. 7 is a view along cross-section AA of FIG. 4 and shows the assembly of the reinforcing panel 13 and the second ply 9 through the window 14. The reinforcing panel 13 and the second ply 9 are integral with each other at a junction zone (18), as are two layers of sheet material internal to the second ply 9. The reinforcing panel 13 thus allows transmission of forces between the lower part of the saddle tree 1 and the second ply 9 which makes up the seat 3, that is between the mount and the rider.

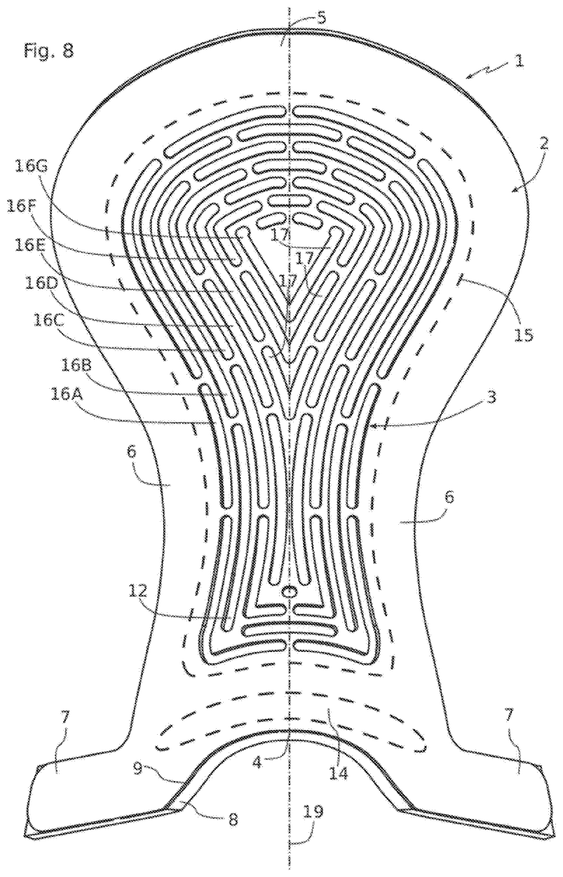

With reference to FIG. 8, the saddle tree 1 is seen from above and the contours of the frame 2 consisting of the first ply 8 are represented in dotted lines. The contours of the window 14 are also represented in dotted lines. The patterns created by the grooves 12 are additionally visible in this top view.

The grooves 12 allow local deformations of the second ply 9, by bending portions of the seat 3, to offer the rider flexibility and comfort. To this end, the grooves 12 are disposed in a staggered pattern and extend substantially along lines that follow the inner contour 15 of the framework 10.

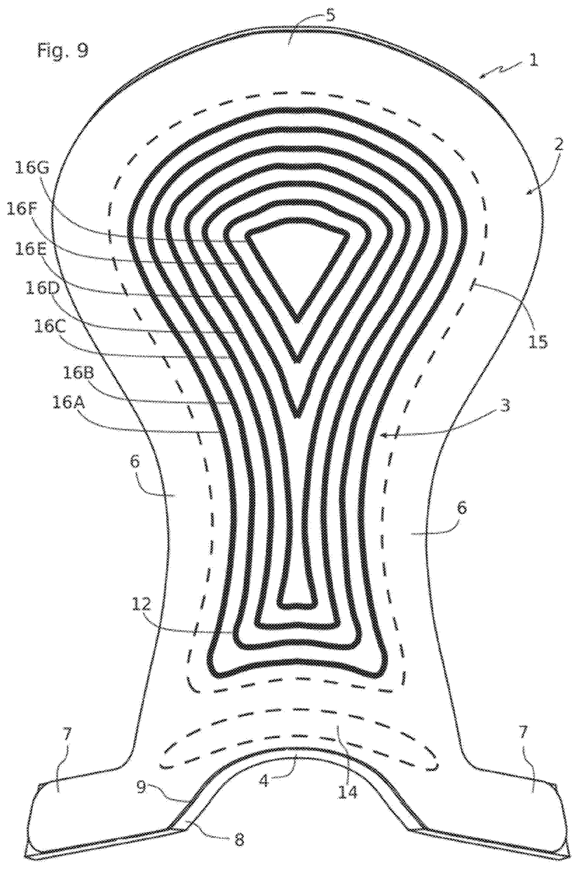

FIG. 9 schematically illustrates the lines along which the grooves 12 extend.

With reference to FIGS. 8 and 9 together, the grooves 12 are disposed, in the present example, along seven contour lines 16A to 16G. These lines intimately follow the inner contour 15. The most peripheral lines (16A to 16D) follow a path very close to the inner contour 15, while the more central lines (16E to 16G) fill in the remaining space up to the most central line 16G. In the path of each of these three most central lines 16E, 16F, 16G, the second ply 9 comprises a central V-shaped groove 17. These grooves 17 are said to be central because the tip of their V-shape is disposed in a vertical plane 19 longitudinally intersecting the saddle tree 1 (this plane being perpendicular to the plane of FIG. 8 and thus being represented by a dotted line in this figure). The two edges of this V-shape, extending on either side of the V-tip, correspond to the pressure zone of the rider's hip bones. It is on this zone that the greatest pressure is exerted on the seat 3 and the presence of these grooves provides advantageous dynamic support.

Alternative embodiments of the saddle tree 1 can be implemented without departing from the scope of the invention. For example, the number and nature of the layers of sheet material of the first ply 8 and the second ply 9 may vary depending on the desired rigidity or flexibility, as well as the thickness of these layers.

1-14. (canceled)

15. An equestrian saddle tree comprising a frame forming a pommel and a cantle connected by lateral strips, this saddle tree consisting of a single piece of composite material, the reinforcement of which comprises a plurality of superimposed layers of sheet material, and the matrix of which consists of at least one resin, the frame comprising:
a first ply comprising at least one layer of sheet material, this first ply making up a framework which has an inner contour defining a central opening;
a second ply superimposed on the first ply and comprising at least one layer of sheet material, the second ply further extending over the central opening and making up a rider's seat.

16. The saddle tree according to claim 15, wherein the first ply consists of a plurality of layers of sheet material.

17. The saddle tree according to claim 16, wherein the layers of sheet material of the first ply are layers of wood sheets.

18. The saddle tree according to claim 15, wherein the second ply consists of a plurality of layers of sheet material.

19. The saddle tree according to claim 18, wherein the layers of sheet material of the second ply are layers of woven fiber sheets.

20. The saddle tree according to claim 19, wherein the woven fibers are carbon fibers.

21. The saddle tree according to claim 15, comprising a reinforcing panel disposed against the first ply, at the pommel, on the face of the first ply that is opposite to the second ply.

22. The saddle tree according to claim 21, comprising a window provided in the first ply, the second ply and the reinforcing panel being attached against each other through the window, in a junction zone.

23. The saddle tree according to claim 21, wherein the reinforcing panel is made of a stack of layers of the same sheet material as the sheet material of the second ply.

24. The saddle tree according to claim 21, wherein the reinforcing panel comprises a matrix made of the same resin forming the matrix of the second ply, this resin being also present in the junction zone between the second ply and the reinforcing panel.

25. The saddle tree according to claim 15, wherein the second ply comprises through opening grooves facing the central opening.

26. The saddle tree according to claim 25, wherein the grooves are arranged in a staggered pattern.

27. The saddle tree according to claim 25, wherein the grooves are disposed as lines substantially intimately following the shape of the inner contour of the framework.

28. The saddle tree according to claim 25, wherein at least one of the grooves is V-shaped, the tip of this V-shape being disposed in a vertical plane intersecting longitudinally the saddle tree.
